(19) United States
(12) Patent Application Publication
(10) Pub. No.: US 2025/0139588 A1
(43) Pub. Date: May 1, 2025

(54) SCHEDULE CREATION METHOD AND SYSTEM, DEVICE, AND MEDIUM

(71) Applicant: Beijing Zitiao Network Technology Co., Ltd., Beijing (CN)

(72) Inventors: Zhenyi Huang, Beijing (CN); Xinya Ma, Beijing (CN); Kang Zheng, Beijing (CN); Yuanyuan Shang, Beijing (CN)

(21) Appl. No.: 18/930,890

(22) Filed: Oct. 29, 2024

(30) Foreign Application Priority Data
Oct. 30, 2023 (CN) 202311423134.X

(51) Int. Cl. G06Q 10/1093

(52) U.S. Cl. CPC G06Q 10/1093

(57) ABSTRACT

The present application provides a schedule creation method and system, a device, and a medium. The method includes: obtaining information to be processed in response to an input request triggered on a schedule creation page, where the information to be processed is configured to represent natural language content, wherein the information to be processed is configured to indicate the generation of a target schedule; displaying, on the schedule creation page based on the information to be processed, schedule information including a plurality of schedule configuration items; and creating the target schedule in response to a confirmation operation for the schedule information.

### CROSS-REFERENCE TO RELATED APPLICATION(S)

This application claims priority to Chinese Application No. 202311423134.X filed Oct. 30, 2023, the disclosure of which is incorporated herein by reference in its entity.

### FIELD

The present application relates to the field of computer technologies, and in particular to a schedule creation method and system, an electronic device, and a computer-readable storage medium.

### BACKGROUND

With the continuous development of computer technology, office automation (OA), which combines computer technology and modern office, has emerged. The office automation can realize the automated processing of office procedures, greatly improving the work efficiency of individual or group office procedures.

Enterprises can use an OA system (such as a business platform or a business system) to assist in office work. The OA system usually includes a schedule module, which can be used to create and manage user schedules, so as to clearly and reasonably arrange the user schedules.

Specifically, a user can enter a plurality of schedule configuration items, such as a schedule subject, a schedule time, and a schedule participant, on a page provided by the schedule module, so as to create a schedule. However, for a piece of schedule information, the above method requires the user to enter the schedule configuration items one by one, resulting in cumbersome operations and low schedule creation efficiency.

### SUMMARY

The present application provides a schedule creation method. The method allows a user to automatically generate schedule information by entering natural language in a schedule creation page, so as to implement automatic creation of a schedule. The present application further provides a system corresponding to the method, an electronic device, a computer-readable storage medium, and a computer program product.

In a first aspect, the present application provides a schedule creation method. The method includes:
obtaining information to be processed in response to an input request triggered on a schedule creation page, the information to be processed being configured to represent natural language content, wherein the information to be processed is configured used to indicate the generation of a target schedule;
displaying, on the schedule creation page based on the information to be processed, schedule information including a plurality of schedule configuration items; and
creating the target schedule in response to a confirmation operation for the schedule information.

In some possible implementations, the obtaining information to be processed in response to an input request triggered on a schedule creation page includes:
obtaining input information in the schedule creation page in response to the input request triggered on the schedule creation page; and
generating the information to be processed based on the input information.

In some possible implementations, the obtaining information to be processed in response to an input request triggered on a schedule creation page includes:
displaying at least one schedule creation template in response to the input request triggered on the schedule creation page;
displaying template content of a target schedule creation template in response to a selection operation for the at least one schedule creation template; and
in response to an input operation on the schedule creation page, generating the information to be processed based on the template content of the target schedule creation template and input information in the schedule creation page.

In some possible implementations, the obtaining information to be processed in response to an input request triggered on a schedule creation page includes:
displaying at least one schedule creation control in response to the input request triggered on the schedule creation page; and
in response to a trigger operation for a target schedule creation control of the at least one schedule creation control, generating the information to be processed based on creation information indicated by the target schedule creation control.

In some possible implementations, the displaying, on the schedule creation page based on the information to be processed, schedule information including a plurality of schedule configuration items includes:
generating the plurality of schedule configuration items in sequence based on the information to be processed and a positional relationship between display areas of the plurality of schedule configuration items in the schedule creation page; and
for a target schedule configuration item of the plurality of schedule configuration items, displaying the target schedule configuration item on the schedule creation page in response to the generation of the target schedule configuration item being completed.

In some possible implementations, the method further includes:
displaying a prompt interface in a display area corresponding to the target schedule configuration item in the schedule creation page in response to the target schedule configuration item being generated, where display content in the prompt interface indicates that the target schedule configuration item is being generated.

In some possible implementations, the method further includes:
regenerating the plurality of schedule configuration items in sequence in response to a retry operation triggered on the schedule creation page; or
stopping the generation of the plurality of schedule configuration items in response to a stop operation triggered on the schedule creation page.

In some possible implementations, the displaying, on the schedule creation page based on the information to be processed, schedule information including a plurality of schedule configuration items includes:
sending the information to be processed to a language model, and receiving the plurality of schedule configuration items generated by the language model; and
displaying, on the schedule creation page, the schedule information including the plurality of schedule configuration items.

In some possible implementations, the method further includes:
receiving input information in response to a trigger operation for the target schedule configuration item of the plurality of schedule configuration items; and
displaying the updated target schedule configuration item in the display area of the target schedule configuration item based on the input information.

In a second aspect, the present application provides a schedule creation system. The system includes:
an obtaining module configured to obtain information to be processed in response to an input request triggered on a schedule creation page, the information to be processed being configured to represent natural language content, wherein the information to be processed is configured to indicate the generation of a target schedule;
a display module configured to display, on the schedule creation page based on the information to be processed, schedule information including a plurality of schedule configuration items; and
a creation module configured to create the target schedule in response to a confirmation operation for the schedule information.

In some possible implementations, the obtaining module is specifically configured to:
obtain input information in the schedule creation page in response to the input request triggered on the schedule creation page; and
generate the information to be processed based on the input information.

In some possible implementations, the obtaining module is specifically configured to:
display at least one schedule creation template in response to the input request triggered on the schedule creation page;
display template content of a target schedule creation template in response to a selection operation for the at least one schedule creation template; and
in response to an input operation on the schedule creation page, generate the information to be processed based on the template content of the target schedule creation template and input information in the schedule creation page.

In some possible implementations, the obtaining module is specifically configured to:
display at least one schedule creation control in response to the input request triggered on the schedule creation page; and
in response to a trigger operation for a target schedule creation control of the at least one schedule creation control, generate the information to be processed based on creation information indicated by the target schedule creation control.

In some possible implementations, the display module is specifically configured to:
generate the plurality of schedule configuration items in sequence based on the information to be processed and a positional relationship between display areas of the plurality of schedule configuration items in the schedule creation page; and
for a target schedule configuration item of the plurality of schedule configuration items, display the target schedule configuration item on the schedule creation page in response to the generation of the target schedule configuration item being completed.

In some possible implementations, the display module is further configured to:
display a prompt interface in a display area corresponding to the target schedule configuration item in the schedule creation page in response to the target schedule configuration item being generated, where display content in the prompt interface indicates that the target schedule configuration item is being generated.

In some possible implementations, the display module is further configured to:
regenerate the plurality of schedule configuration items in sequence in response to a retry operation triggered on the schedule creation page; or
stop the generation of the plurality of schedule configuration items in response to a stop operation triggered on the schedule creation page.

In some possible implementations, the display module is specifically configured to:
send the information to be processed to a language model, and receiving the plurality of schedule configuration items generated by the language model; and
display, on the schedule creation page, the schedule information including the plurality of schedule configuration items.

In some possible implementations, the display module is further configured to:
receive input information in response to a trigger operation for the target schedule configuration item of the plurality of schedule configuration items; and
display the updated target schedule configuration item in the display area of the target schedule configuration item based on the input information.

In a third aspect, the present application provides an electronic device. The electronic device includes a processor and a memory. The processor and the memory communicate with each other. The processor is configured to execute instructions stored in the memory to cause the electronic device to perform the schedule creation method of the first aspect or any one of the implementations of the first aspect.

In a fourth aspect, the present application provides a computer-readable storage medium having instructions stored therein, where the instructions instruct an electronic device to perform the schedule creation method of the first aspect or any one of the implementations of the first aspect.

In a fifth aspect, the present application provides a computer program product including instructions, where the computer program product, when running on an electronic device, causes the electronic device to perform the schedule creation method of the first aspect or any one of the implementations of the first aspect.

Based on the implementations provided in the above aspects, the present application may further combine the implementations to provide more implementations.

It can be seen from the above technical solutions that the present application has the following advantages:

The present application provides a schedule creation method. The method includes: obtaining information to be processed in response to an input request triggered on a schedule creation page, where the information to be processed is configured to represent natural language content, wherein the information to be processed is configured to indicate the generation of a target schedule; then displaying, on the schedule creation page based on the information to be processed, schedule information including a plurality of schedule configuration items; and creating the target schedule in response to a confirmation operation for the schedule information.

The method allows a user to trigger automatic creation of a schedule by entering the natural language content in the schedule creation page. Based on the information to be processed that is entered by the user, the plurality of schedule configuration items are generated for the user to preview, and the schedule is automatically created after confirmation by the user. In this way, for a piece of schedule information, the user does not need to manually enter information for each of the plurality of schedule configuration items in the schedule creation page, thereby improving the schedule creation efficiency.

### BRIEF DESCRIPTION OF THE DRAWINGS

In order to more clearly illustrate the technical method of the embodiments of the present application, the accompanying drawings required for use in the embodiments are briefly described below.

FIG. 1 is a schematic flowchart of a schedule creation method according to an embodiment of the present application;

FIG. 2A to FIG. 2G are schematic diagrams of a schedule creation page according to an embodiment of the present application;

FIG. 3 is a schematic diagram of a structure of a schedule creation system according to an embodiment of the present application; and

FIG. 4 is a schematic diagram of a structure of an electronic device according to an embodiment of the present application.

### DETAILED DESCRIPTION OF EMBODIMENTS

The terms “first” and “second” in the embodiments of the present application are used for descriptive purposes only and should not be understood as indicating or implying relative importance or implicitly indicating the number of the indicated technical features. Therefore, a feature defined by “first” or “second” may explicitly or implicitly include one or more such features.

First, some technical terms involved in the embodiments of the present application are described.

With the continuous development of computer technology, office automation (OA), which combines computer technology and modern office, has emerged. The office automation can realize the automated processing of office procedures, greatly improving the work efficiency of individual or group office procedures.

Specifically, enterprises can use an OA system (such as a business platform or a business system) to assist in office work. The OA system usually includes a plurality of system modules that provide different functions, such as an instant messaging module, a form module, a task management module, a meeting module, and a schedule module.

The schedule module can be used to create and manage user schedules, so as to clearly and reasonably arrange the user schedules. In addition, the schedule module further supports viewing other users' schedules, so as to straightforwardly obtain other users' free time and improve collaboration efficiency.

During the creation of a schedule, a user may enter a plurality of schedule configuration items, such as a schedule subject, a schedule time, and a schedule participant, on a page provided by the schedule module, so as to create the schedule. However, the above method requires the user to enter the schedule configuration items one by one, resulting in cumbersome operations and low schedule creation efficiency.

In view of this, the present application provides a schedule creation method. The method includes: obtaining information to be processed in response to an input request triggered on a schedule creation page, where the information to be processed is configured to represent natural language content, wherein the information to be processed is configured to indicate the generation of a target schedule; then displaying, on the schedule creation page based on the information to be processed, schedule information including a plurality of schedule configuration items; and creating the target schedule in response to a confirmation operation for the schedule information.

The method allows a user to trigger automatic creation of a schedule by entering the natural language content in the schedule creation page. Based on the information to be processed that is entered by the user, the plurality of schedule configuration items are generated for the user to preview, and the schedule is automatically created after confirmation by the user. In this way, for a piece of schedule information, the user does not need to manually enter information for each of the plurality of schedule configuration items in the schedule creation page, thereby improving the schedule creation efficiency.

To facilitate an understanding of the technical solutions provided by the embodiments of the present application, description is given below in conjunction with the accompanying drawings.

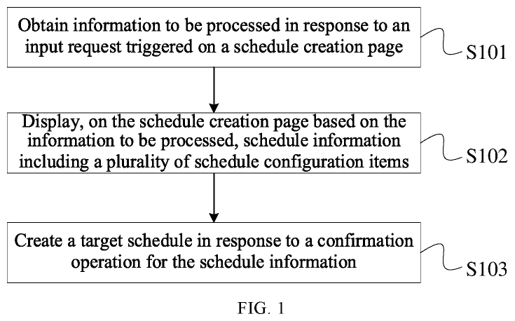

Referring to FIG. 1, which is a schematic flowchart of a schedule creation method according to an embodiment of the present application, the method specifically includes the following steps.

At S101, information to be processed is obtained in response to an input request triggered on a schedule creation page.

The schedule creation page may be understood as a page used to create or edit a schedule. Depending on application scenarios, the schedule creation page may have different presentation forms. For example, when a user uses an independent schedule tool to create a schedule, the schedule creation page may be a page loaded in a client corresponding to the schedule tool. For another example, when the user creates a schedule using a schedule tool (e.g., the schedule module in the business platform) deployed in another system (e.g., the business platform), the schedule creation page may be a page loaded in a client corresponding to the another system. For another example, when the user creates a schedule using a schedule tool that can be used online, the schedule creation page may be a page displayed in a browser.

The input request may be understood as a request for entering information in the schedule creation page. In some embodiments, the schedule creation page includes a dialogue window, which may provide an input box. The user may generate the input request by triggering the input box, for example, by clicking the input box with a mouse, touching the input box with a touchpad, triggering the input box with a shortcut key, or triggering the input box with a voice command.

The information to be processed may include information entered by the user on the schedule creation page, for example, information entered after the input box is triggered in the dialogue window of the schedule creation page. In the embodiment of the present application, the information to be processed may be used to indicate the creation of a target schedule. Generally, the information to be processed may be used to represent natural language content. For example, the information to be processed may include content for describing requirements such as a target schedule subject, a target schedule time, and a target schedule participant. In this way, the user indicates the intention to create the target schedule by entering natural language.

One schedule usually includes a plurality of schedule configuration items. On the schedule creation page, the plurality of schedule configuration items may be displayed in display areas corresponding to the plurality of schedule configuration items. Considering that the user may manually enter information for the plurality of schedule configuration items in the schedule creation page to create the schedule, or may use the schedule creation method according to the embodiment of the present application to create the schedule, an entry to the dialogue window may be provided on the schedule creation page.

In a specific implementation, the dialogue window is displayed in response to a trigger operation in a first display area in the schedule creation page. In other words, the dialogue window is not displayed the moment the user enters the schedule creation page, and the dialogue window is displayed only when the user triggers the first area in the schedule creation page.

The first area may be used to display a first schedule configuration item, and the first schedule configuration item may be one of the plurality of schedule configuration items. In some embodiments, the display area of the first schedule configuration item may be a schedule configuration item located at the topmost of the schedule creation page, such as a schedule subject. In this way, when the user creates the schedule in the schedule creation page, the dialogue window can be quickly called. For example, when the mouse is placed in the display area of the first schedule configuration item, the trigger operation is generated, and the dialogue window is displayed, such that the user can enter the information to be processed in the dialogue window.

In the embodiments of the present application, the information to be processed may be obtained in different ways. In some embodiments, input information in the schedule creation page may be obtained in response to the input request triggered on the schedule creation page; wherein the information to be processed may be generated based on the input information. That is, the user may enter information described in natural language in the schedule creation page (e.g., the dialogue window of the schedule creation page), and the input information may be used as the information to be processed to indicate the generation of the target schedule.

In some other embodiments, at least one schedule creation template may be displayed in response to the input request triggered on the schedule creation page; template content of the schedule creation template may be displayed in response to a selection operation for the at least one schedule creation template; and in response to an input operation in the schedule creation page, the information to be processed may be generated based on a target schedule creation template and input information of the schedule creation page. That is, by providing the user with the schedule creation template, the user can enter information based on the template content of the schedule creation template, and the template content of the schedule creation template and the information entered by the user are used as the information to be processed, so as to use the schedule creation template to assist the user in entering information.

In some other embodiments, at least one schedule creation control may be displayed in response to the input request triggered on the schedule creation page; and in response to a trigger operation for a target schedule creation control of the at least one schedule creation control, the information to be processed may be generated based on creation information indicated by the target schedule creation control. That is, by providing the user with the schedule creation control, the user can quickly enter the information to be processed by directly triggering the schedule creation control.

At S102, schedule information including a plurality of schedule configuration items is displayed on the schedule creation page based on the information to be processed.

After the information to be processed is obtained, the plurality of schedule configuration items may be generated based on the information to be processed. The plurality of schedule configuration items may be used to describe the target schedule from different aspects, and the schedule configuration items include but are not limited to a schedule subject, a schedule time, a schedule participant, a venue of use, a schedule agenda, etc. When the schedule configuration item is the schedule subject, the content of the schedule configuration item may be a project discussion meeting, a requirements review meeting, etc. When the schedule configuration item is schedule duration, the content of the schedule configuration item may be 1 hour, 2 hours, etc.

In a specific implementation, the information to be processed may be sent to a language model, and the plurality of schedule configuration items generated by the language model may be received; and the schedule information including the plurality of schedule configuration items may then be displayed in the schedule creation page. The language model may be a model with semantic understanding and semantic analysis functions and natural language processing capabilities, such as a deep learning model trained using text data.

In some embodiments, the language model may be a model deployed in a schedule tool, and the plurality of schedule configuration items may be directly generated by entering the information to be processed into the language model. In some other embodiments, the language model may also be an external model, and after the information to be processed is obtained, the plurality of schedule configuration items may be generated by calling the language model. In this way, the language model is configured to identify and understand the intention of the user to create the schedule, so that the user can obtain the schedule information including the plurality of schedule configuration items by entering natural language.

In some possible implementations, considering that there are a large number of schedule configuration items, the plurality of schedule configuration items may be generated in sequence. In a specific implementation, the plurality of schedule configuration items may be generated in sequence based on the information to be processed and a positional relationship between display areas of the plurality of schedule configuration items in the schedule creation page. For example, the plurality of schedule configuration items may be generated in sequence from top to bottom based on the positional relationship between the display areas of the plurality of schedule configuration items in the schedule creation page. In this way, the plurality of schedule configuration items are generated in sequence in a certain generation order, thereby improving the efficiency of generation of the schedule information.

Further, after the plurality of schedule configuration items are generated, the plurality of schedule configuration items may be displayed on the schedule creation page. When the plurality of schedule configuration items are generated in sequence, for a target schedule configuration item of the plurality of schedule configuration items, the target schedule configuration item may be displayed in the display area of the target schedule configuration item in the schedule creation page in response to the generation of the target schedule configuration item being completed. In this way, the moment one schedule configuration item is generated, the schedule configuration item is displayed, and the user is informed of the generation progress in real time, such that the user can view the schedule information in real time.

In addition, during generation of the plurality of schedule configuration items, a prompt interface may further be provided in the schedule creation page. Specifically, a prompt interface may be displayed in the display area corresponding to the target schedule configuration item in the schedule creation page in response to the target schedule configuration item being generated, where display content in the prompt interface indicates that the target schedule configuration item is being generated. In some embodiments, the prompt interface may be a dialogue window in the schedule creation page. In this way, the dialogue window is displayed in the display area corresponding to the schedule configuration item currently being generated, and the dialogue window moves along to inform the user of the generation progress in real time.

During generation of the schedule configuration items, the user may further perform a retry or stop operation. Specifically, the plurality of schedule configuration items are regenerated in sequence in response to a retry operation triggered on the schedule creation page; or the generation of the plurality of schedule configuration items is stopped in response to a stop operation triggered on the schedule creation page.

In other words, for the target schedule configuration item being generated, the user may trigger the retry operation or the stop operation, for example, by means of the prompt interface provided in the display area of the target schedule configuration item, thereby controlling the schedule information generation process.

At S103, the target schedule is created in response to a confirmation operation for the plurality of pieces of schedule information.

The confirmation operation may be understood as an operation of confirming the plurality of schedule configuration items as the target schedule. In other words, the user may view the plurality of schedule configuration items automatically generated to determine whether the current schedule information meets user requirements, and confirm whether the user requirements are met, thereby implementing automatic creation of the target schedule. In a specific implementation, the schedule information may be filled into the corresponding schedule configuration items in the schedule module to create the target schedule.

In addition, the user may also add schedule information corresponding to other schedule configuration items based on the plurality of schedule configuration items currently generated, such as adding a new venue of use, adding a new schedule description, and adding a new meeting minutes, so as to enrich the schedule content.

Correspondingly, if the current schedule information does not meet the user requirements, the user may also trigger the retry operation or a discard operation, thereby regenerating or discarding the plurality of schedule configuration items.

In a specific implementation, input information is received in response to a trigger operation for a target schedule configuration item of the plurality of schedule configuration items; and the updated target schedule configuration item is displayed in the display area of the target schedule configuration item based on the input information.

In other words, the embodiments of the present application allow the user to modify each schedule configuration item by entering information. For example, after the user triggers the target schedule configuration item, an input box may be displayed in the display area of the target schedule configuration item, and the user may enter information in the input box.

Further, the input information may be used to indicate the modified content of the target schedule configuration item. For example, the target schedule configuration item is a reserved conference room. If the user is not satisfied with the currently reserved conference room, the user may trigger a target control and enter “Change the meeting room for me” to modify the target schedule configuration item. The updated target schedule configuration item is displayed in the display area of the target schedule configuration item.

Based on the above description, an embodiment of the present application provides a schedule creation method. The method includes: obtaining information to be processed in response to an input request triggered on a schedule creation page, where the information to be processed is configured to represent natural language content, wherein the information to be processed is configured to indicate the generation of a target schedule; then displaying, on the schedule creation page based on the information to be processed, schedule information including a plurality of schedule configuration items; and creating the target schedule in response to a confirmation operation for the schedule information.

The method allows a user to trigger automatic creation of a schedule by entering the natural language content in the schedule creation page. Based on the information to be processed that is entered by the user, the plurality of schedule configuration items are generated for the user to preview, and the schedule is automatically created after confirmation by the user. In this way, for a piece of schedule information, the user does not need to manually enter information for each of the plurality of schedule configuration items in the schedule creation page, thereby improving the schedule creation efficiency.

The schedule creation method provided by the present application will be described below in conjunction with specific application scenarios.

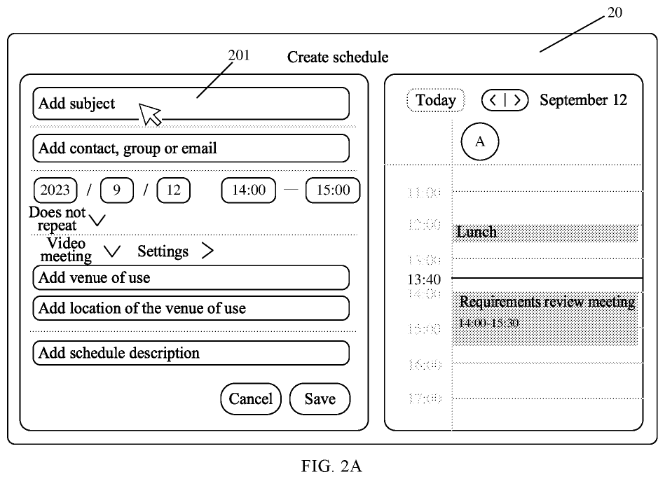

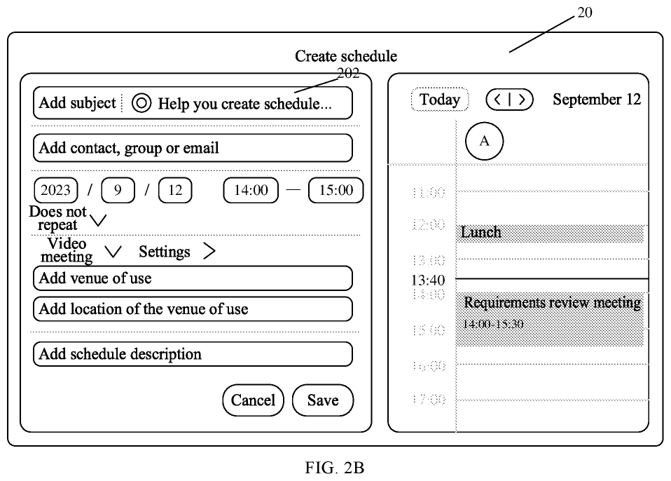

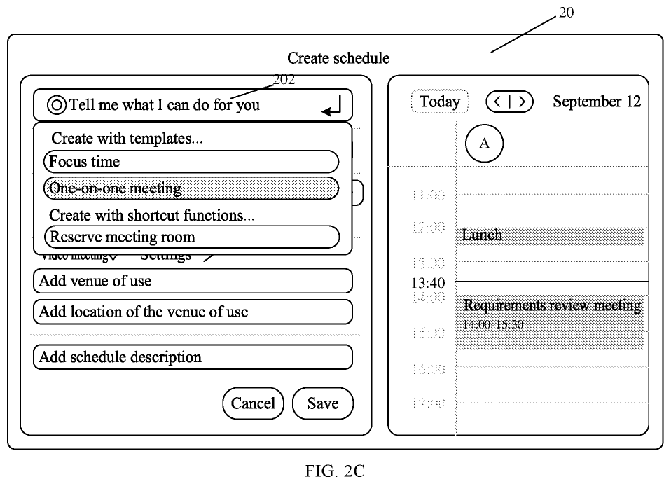

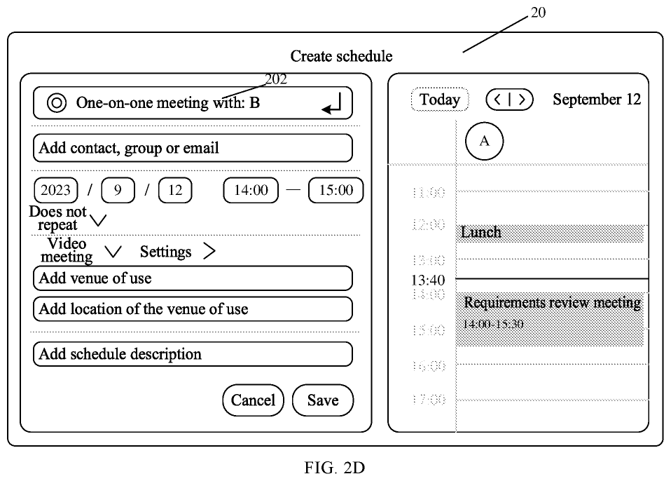

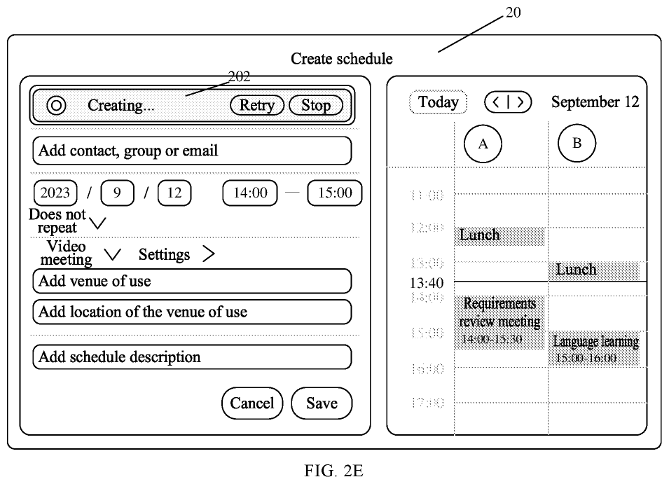

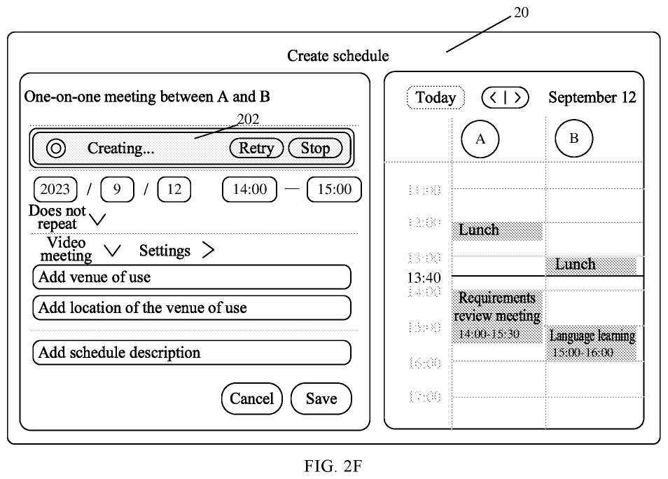

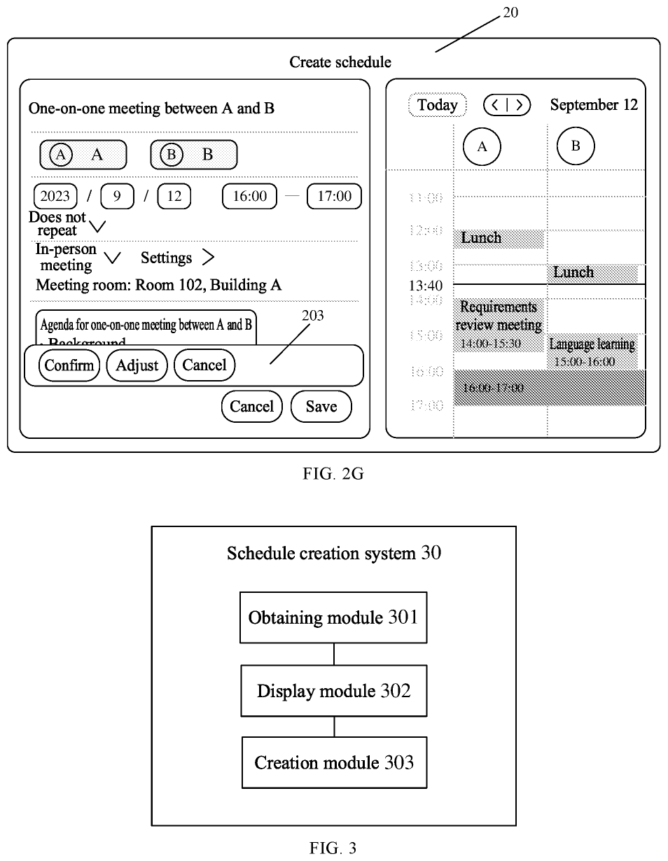

Referring to FIG. 2A, which is a schematic diagram of a schedule creation page, a schedule creation page 20 includes a schedule configuration item editing area (the left area in FIG. 2D) and a schedule viewing area (the right area in FIG. 2D). The user can view the schedule arrangement of the current user or a schedule participant in the schedule viewing area, and modify or add schedule configuration items in the schedule configuration item editing area, so as to edit the target schedule. The schedule configuration item editing area includes a first display area 201, and the first display area 201 is configured to display a first schedule configuration item, such as a schedule subject.

When the user triggers the first display area 201, for example, by placing a mouse in the first display area 201, a dialogue window may be displayed. As shown in FIG. 2B, the schedule creation page 20 provides a dialogue window 202, and the dialogue window 202 is configured to receive content entered by the user.

Information to be processed may be obtained in response to an input request triggered on the schedule creation page 20 (e.g., the dialogue window 202). As shown in FIG. 2C, the user may trigger the input request in the dialogue window 202, for example, by clicking the dialogue window 202, such that the user can enter in the dialogue window 202. For example, the user may directly enter information in the dialogue window 202. For another example, the user may also use a schedule creation template to assist in entering information. For another example, the user may also quickly enter information by means of the schedule creation control.

An example in which the user uses the schedule creation template to assist in entering information is used for description. As shown in FIG. 2D, after the user selects the schedule creation template “One-on-one meeting”, the “One-on-one meeting” may be displayed in the dialogue window 202. The user may then enter information on this basis to obtain the information to be processed, wherein the information to be processed “One-on-one meeting with: B” is displayed in the dialogue window 202.

After the user sends the information to be processed, a plurality of schedule configuration items may start to be generated. As shown in FIG. 2E, the plurality of schedule configuration items may be generated in sequence, for example, from top to bottom, based on a positional relationship between display areas of the plurality of schedule configuration items in the schedule creation page. For the target schedule configuration item that is being generated, the dialogue window 202 may be displayed in the display area corresponding to the target schedule configuration item. For example, the “schedule subject”, as the schedule configuration item located at the topmost in the schedule creation page 20, may be generated first. During this process, the dialogue window 202 may be displayed in the display area corresponding to the schedule subject, and the content “Creating . . . ” may be displayed in the dialogue window 202.

After the schedule subject is generated, the dialogue window 202 may move to the display area corresponding to the next schedule configuration item to be generated for display. As shown in FIG. 2F, the dialogue window 202 may be displayed in the display area corresponding to the schedule participant, thereby informing the user that the schedule configuration item currently being generated is the schedule participant. In this way, the user is informed of the generation progress in real time by the movement of the dialogue window 202.

In addition, the dialogue window 202 further provides a retry control and a stop control. The user may trigger the retry control to regenerate the plurality of schedule configuration items in sequence, or may trigger the stop control to stop the generation of the target schedule configuration item, thereby controlling the schedule information generation process.

After the plurality of schedule configuration items are generated, the user may perform a confirm, adjust, or cancel operation for the plurality of schedule configuration items. As shown in FIG. 2G, the schedule creation page 20 includes a control bar 203, and the control bar 203 includes a confirm control, an adjust control, and a cancel control. The confirm control is configured to trigger the confirmation operation for the plurality of schedule configuration items, thereby implementing automatic creation of the target schedule. The adjust control is configured to trigger the adjustment operation for the plurality of schedule configuration items, such as regenerating a schedule configuration item. The cancel control is configured to trigger the discard operation for the plurality of schedule configuration items, thereby discarding the plurality of schedule configuration items currently generated.

The schedule creation method according to the embodiment of the present application has been described in detail above in conjunction with FIG. 1 and FIG. 2. The system and device according to embodiments of the present application will be described below in conjunction with the accompanying drawings.

Referring to FIG. 3, which is a schematic diagram of a structure of a schedule creation system shown, the system 30 includes:
an obtaining module 301 configured to obtain information to be processed in response to an input request triggered on a schedule creation page, the information to be processed being configured to represent natural language content, wherein the information to be processed is configured to indicate generation of a target schedule;
a display module 302 configured to display, on the schedule creation page based on the information to be processed, schedule information including a plurality of schedule configuration items; and
a creation module 303 configured to create the target schedule in response to a confirmation operation for the schedule information.

In some possible implementations, the obtaining module 301 is specifically configured to:
obtain input information in the schedule creation page in response to the input request triggered on the schedule creation page; and
generate the information to be processed based on the input information.

In some possible implementations, the obtaining module 301 is specifically configured to:
display at least one schedule creation template in response to the input request triggered on the schedule creation page;
display template content of a target schedule creation template in response to a selection operation for the at least one schedule creation template; and
in response to an input operation on the schedule creation page, generate the information to be processed based on the template content of the target schedule creation template and input information in the schedule creation page.

In some possible implementations, the obtaining module 301 is specifically configured to:
display at least one schedule creation control in response to the input request triggered on the schedule creation page; and
in response to a trigger operation for a target schedule creation control of the at least one schedule creation control, generate the information to be processed based on creation information indicated by the target schedule creation control.

In some possible implementations, the display module 302 is specifically configured to:
generate the plurality of schedule configuration items in sequence based on the information to be processed and a positional relationship between display areas of the plurality of schedule configuration items in the schedule creation page; and
for a target schedule configuration item of the plurality of schedule configuration items, display the target schedule configuration item on the schedule creation page in response to the generation of the target schedule configuration item being completed.

In some possible implementations, the display module 302 is further configured to:
display a prompt interface in a display area corresponding to the target schedule configuration item in the schedule creation page in response to the target schedule configuration item being generated, where display content in the prompt interface indicates that the target schedule configuration item is being generated.

In some possible implementations, the display module 302 is further configured to:
regenerate the plurality of schedule configuration items in sequence in response to a retry operation triggered on the schedule creation page; or
stop the generation of the plurality of schedule configuration items in response to a stop operation triggered on the schedule creation page.

In some possible implementations, the display module 302 is specifically configured to:
send the information to be processed to a language model, and receiving the plurality of schedule configuration items generated by the language model; and
display, on the schedule creation page, the schedule information including the plurality of schedule configuration items.

In some possible implementations, the display module 302 is further configured to:
receive input information in response to a trigger operation for the target schedule configuration item of the plurality of schedule configuration items; and
display the updated target schedule configuration item in the display area of the target schedule configuration item based on the input information.

The schedule creation system 30 according to the embodiment of the present application may correspond to performing the method described in the embodiment of the present application, and the above and other operations and/or functions of the modules/units of the schedule creation system 30 are respectively intended to implement corresponding procedures of the method in the embodiment shown in FIG. 1, which will not be described herein again for the sake of brevity.

An embodiment of the present application further provides an electronic device. The electronic device is specifically configured to implement the functions of the schedule creation system 30 in the embodiment as shown in FIG. 3.

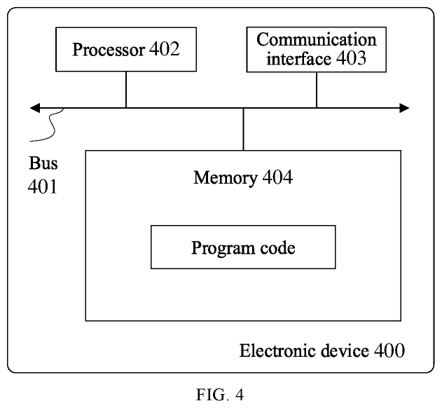

FIG. 4 provides a schematic diagram of a structure of an electronic device 400. As shown in FIG. 4, the electronic device 400 includes a bus 401, a processor 402, a communication interface 403, and a memory 404. The processor 402, the memory 404, and the communication interface 403 communicate with each other by means of the bus 401.

The bus 401 may be a peripheral component interconnect (PCI) bus or an extended industry standard architecture (EISA) bus, etc. The bus can be divided into an address bus, a data bus, a control bus, etc. For ease of representation, the bus is represented by only one thick line in FIG. 4, but this does not mean that there is only one bus or only one type of bus.

The processor 402 may be any one or more of a central processing unit (CPU), a graphics processing unit (GPU), a microprocessor (MP), or a digital signal processor (DSP), etc.

The communication interface 403 is used for communication with the outside. For example, the communication interface 403 may be used for communication with a terminal.

The memory 404 may include a volatile memory, such as a random access memory (RAM). The memory 404 may also include a non-volatile memory, such as a read-only memory (ROM), a flash memory, a hard disk drive (HDD), or a solid state drive (SSD).

The memory 404 stores executable codes, and the processor 402 executes the executable codes to perform the aforementioned schedule creation method.

Specifically, when implementing the embodiment as shown in FIG. 3, and when the modules or units of the schedule creation system 30 as described in the embodiment of FIG. 3 are implemented by software, the software or program codes required to execute the functions of the modules/units in FIG. 3 may be partially or completely stored in the memory 404. The processor 402 executes the program codes corresponding to the units stored in the memory 404 to perform the aforementioned schedule creation method.

An embodiment of the present application further provides a computer-readable storage medium. The computer-readable storage medium may be any available medium that can be stored in a computing device, or a data storage device such as a data center containing one or more available media. The available medium may be a magnetic medium (for example, a floppy disk, a hard disk, or a magnetic tape), an optical medium (for example, a DVD), or a semiconductor medium (for example, a solid state disk), etc. The computer-readable storage medium includes instructions to instruct the computing device to perform the schedule creation method applied to the schedule creation system 30.

An embodiment of the present application further provides a computer program product, which includes one or more computer instructions. When the computer instructions are loaded and executed on the computing device, the procedures or functions described in the embodiments of the present application are completely or partially generated.

The computer instructions may be stored in the computer-readable storage medium, or may be transmitted from one computer-readable storage medium to another computer-readable storage medium. For example, the computer instructions may be transmitted from one website, computer, or data center to another website, computer, or data center in a wired (for example, a coaxial cable, an optical fiber, or a digital subscriber line (DSL)) or wireless (for example, infrared, radio, or microwave) manner.

When the computer program product is executed by a computer, the computer performs any one of the aforementioned schedule creation methods. The computer program product may be a software installation package. When any one of the aforementioned schedule creation methods is required, the computer program product may be downloaded and executed on the computer.

The flowchart and the block diagram in the accompanying drawings illustrate the possibly implemented architecture, functions, and operations of the system, method, and computer program product according to the embodiments of the present application. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be performed substantially in parallel, or may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present application may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the embodiments of the present application, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present application, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present application. Various modifications to these embodiments are apparent to those skilled in the art, and the general principle defined herein may be practiced in other embodiments without departing from the spirit or scope of the present application. Therefore, the present application is not limited to the embodiments described herein but is to be accorded with the broadest scope consistent with the principle and novel features disclosed herein.

I/We claim:

1. A schedule creation method, comprising:
obtaining information to be processed in response to an input request triggered on a schedule creation page, the information to be processed being configured to represent natural language content, wherein the information to be processed is configured to indicate the generation of a target schedule;
displaying, on the schedule creation page based on the information to be processed, schedule information comprising a plurality of schedule configuration items; and
creating the target schedule in response to a confirmation operation for the schedule information.

2. The method according to claim 1, wherein the obtaining information to be processed in response to an input request triggered on a schedule creation page comprises:
obtaining input information in the schedule creation page in response to the input request triggered on the schedule creation page; and
generating the information to be processed based on the input information.

3. The method according to claim 1, wherein the obtaining information to be processed in response to an input request triggered on a schedule creation page comprises:
displaying at least one schedule creation template in response to the input request triggered on the schedule creation page;
displaying template content of a target schedule creation template in response to a selection operation for the at least one schedule creation template; and
in response to an input operation on the schedule creation page, generating the information to be processed based on the template content of the target schedule creation template and input information in the schedule creation page.

4. The method according to claim 1, wherein the obtaining information to be processed in response to an input request triggered on a schedule creation page comprises:
displaying at least one schedule creation control in response to the input request triggered on the schedule creation page; and
in response to a trigger operation for a target schedule creation control of the at least one schedule creation control, generating the information to be processed based on creation information indicated by the target schedule creation control.

5. The method according to claim 1, wherein the displaying, on the schedule creation page based on the information to be processed, schedule information comprising a plurality of schedule configuration items comprises:
generating the plurality of schedule configuration items in sequence based on the information to be processed and a positional relationship between display areas of the plurality of schedule configuration items in the schedule creation page; and
for a target schedule configuration item of the plurality of schedule configuration items, displaying the target schedule configuration item on the schedule creation page in response to the generation of the target schedule configuration item being completed.

6. The method according to claim 5, further comprising:
displaying a prompt interface in a display area corresponding to the target schedule configuration item in the schedule creation page in response to the target schedule configuration item being generated, wherein display content in the prompt interface indicates that the target schedule configuration item is being generated.

7. The method according to claim 1, further comprising:
regenerating the plurality of schedule configuration items in sequence in response to a retry operation triggered on the schedule creation page.

8. The method according to claim 1, further comprising:
stopping the generation of the plurality of schedule configuration items in response to a stop operation triggered on the schedule creation page.

9. The method according to claim 1, wherein the displaying, on the schedule creation page based on the information to be processed, schedule information comprising a plurality of schedule configuration items comprises:
sending the information to be processed to a language model, and receiving the plurality of schedule configuration items generated by the language model; and
displaying, on the schedule creation page, the schedule information comprising the plurality of schedule configuration items.

10. The method according to claim 1, wherein after the creating the target schedule, the method further comprises:
receiving input information in response to a trigger operation for the target schedule configuration item of the plurality of schedule configuration items; and
displaying the updated target schedule configuration item in the display area of the target schedule configuration item based on the input information.

11. An electronic device, comprising:
a memory storing a computer program thereon; and
a processor for execution of the computer program in the memory to perform:
obtaining information to be processed in response to an input request triggered on a schedule creation page, the information to be processed being configured to represent natural language content, wherein the information to be processed is configured to indicate the generation of a target schedule;
displaying, on the schedule creation page based on the information to be processed, schedule information comprising a plurality of schedule configuration items; and
creating the target schedule in response to a confirmation operation for the schedule information.

12. The electronic device according to claim 11, wherein the obtaining information to be processed in response to an input request triggered on a schedule creation page comprises:
obtaining input information in the schedule creation page in response to the input request triggered on the schedule creation page; and
generating the information to be processed based on the input information.

13. The electronic device according to claim 11, wherein the obtaining information to be processed in response to an input request triggered on a schedule creation page comprises:
displaying at least one schedule creation template in response to the input request triggered on the schedule creation page;
displaying template content of a target schedule creation template in response to a selection operation for the at least one schedule creation template; and
in response to an input operation on the schedule creation page, generating the information to be processed based on the template content of the target schedule creation template and input information in the schedule creation page.

14. The electronic device according to claim 11, wherein the obtaining information to be processed in response to an input request triggered on a schedule creation page comprises:
displaying at least one schedule creation control in response to the input request triggered on the schedule creation page; and
in response to a trigger operation for a target schedule creation control of the at least one schedule creation control, generating the information to be processed based on creation information indicated by the target schedule creation control.

15. The electronic device according to claim 11, wherein the displaying, on the schedule creation page based on the information to be processed, schedule information comprising a plurality of schedule configuration items comprises:
generating the plurality of schedule configuration items in sequence based on the information to be processed and a positional relationship between display areas of the plurality of schedule configuration items in the schedule creation page; and
for a target schedule configuration item of the plurality of schedule configuration items, displaying the target schedule configuration item on the schedule creation page in response to the generation of the target schedule configuration item being completed.

16. The electronic device according to claim 15, further comprising:
displaying a prompt interface in a display area corresponding to the target schedule configuration item in the schedule creation page in response to the target schedule configuration item being generated, wherein display content in the prompt interface indicates that the target schedule configuration item is being generated.

17. The electronic device according to claim 11, further comprising:
regenerating the plurality of schedule configuration items in sequence in response to a retry operation triggered on the schedule creation page; or
stopping the generation of the plurality of schedule configuration items in response to a stop operation triggered on the schedule creation page.

18. The electronic device according to claim 11,
wherein the displaying, on the schedule creation page based on the information to be processed, schedule information comprising a plurality of schedule configuration items comprises:
sending the information to be processed to a language model, and receiving the plurality of schedule configuration items generated by the language model; and
displaying, on the schedule creation page, the schedule information comprising the plurality of schedule configuration items,
and wherein after the creating the target schedule, the method further comprises:
receiving input information in response to a trigger operation for the target schedule configuration item of the plurality of schedule configuration items; and
displaying the updated target schedule configuration item in the display area of the target schedule configuration item based on the input information.

19. A computer-readable non-transitory storage medium, comprising instructions to instruct an electronic device to perform:
obtaining information to be processed in response to an input request triggered on a schedule creation page, the information to be processed being configured to represent natural language content, wherein the information to be processed is configured to indicate the generation of a target schedule;
displaying, on the schedule creation page based on the information to be processed, schedule information comprising a plurality of schedule configuration items; and
creating the target schedule in response to a confirmation operation for the schedule information.

20. The computer-readable non-transitory storage medium according to claim 19, wherein the obtaining information to be processed in response to an input request triggered on a schedule creation page comprises:
obtaining input information in the schedule creation page in response to the input request triggered on the schedule creation page; and
generating the information to be processed based on the input information.
